(19) United States
(12) Patent Application Publication
(10) Pub. No.: US 2019/0263151 A1
(43) Pub. Date: Aug. 29, 2019

(54) PRINTER

(71) Applicant: FUJITSU COMPONENT LIMITED, Tokyo (JP)

(72) Inventors: Ippei OHRUI, Tokyo (JP); Masahiro TSUCHIYA, Tokyo (JP); Tetsuhiro ISHIKAWA, Tokyo (JP)

(21) Appl. No.: 16/343,868

(22) PCT Filed: Oct. 20, 2017
(86) PCT No.: PCT/JP2017/038014

§ 371 Date: Apr. 22, 2019

(30) Foreign Application Priority Data
Oct. 25, 2016 (JP) 2016-208337

(51) Int. Cl. B41J 11/04; B41J 3/407; B41J 2/32; B41J 15/04; B41J 29/13

(52) U.S. Cl. CPC B41J 11/04; B41J 3/4075; B41J 29/13; B41J 15/044; B41J 2/32

(57) ABSTRACT

A printer includes a platen roller that feeds recording paper supplied through a first opening toward a second opening through which the recording paper is ejected, a recording head that prints information on the recording paper, and an attachment part to which a recording paper guide that guides the recording paper or a holder that supports a roll of the recording paper is detachably attached.

### TECHNICAL FIELD

The present invention relates to a printer.

### BACKGROUND ART

Printers for printing receipts are widely used, for example, for cash registers in shops, and for automated teller machines (ATM) and cash dispensers (CD) in banks. In such a printer, information is printed on recording paper by a print (recording) head while the recording paper is being fed, and the recording paper is cut by a cutter.

In this type of printer, a paper roll is used as the recording paper, and information is printed on the recording paper sandwiched between the print head and a platen roller.

### RELATED-ART DOCUMENTS

### Patent Documents

[Patent Document 1] Japanese Laid-Open Patent Publication No. 2013-010269
[Patent Document 2] Japanese Laid-Open Patent Publication No. 2009-096595

### SUMMARY OF INVENTION

### Technical Problem

A printer using a paper roll includes a recording paper holder for holding the paper roll. Printers with various types of recording paper holders are used depending on their purposes and needs. For example, there are a recording paper holder including a paper-feed shaft for supporting a paper roll and a recording paper holder configured to house a paper roll.

Also, printers are used in various manners. For example, a printer may be used as a built-in unit of a ticketing device or as a stand-alone device. Here, printers used as a built-in unit and a stand-alone device have different purposes and use environments and are therefore designed according to different concepts. However, if a printer used as a stand-alone device can also be used as a built-in unit of a ticketing device, it is possible to use the same components for the stand-alone device and the built-in unit and provide printers with low costs.

Also, it is preferable to configure a printer to be able to use both cut sheets and paper rolls to improve the versatility of the printer

### Solution to Problem

According to an aspect of the present invention, a printer includes a platen roller that feeds recording paper supplied through a first opening toward a second opening through which the recording paper is ejected, a recording head that prints information on the recording paper, and an attachment part to which a recording paper guide that guides the recording paper or a holder that supports a roll of the recording paper is detachably attached.

### Advantageous Effects of Invention

An aspect of the present invention makes it possible to provide a printer that can print information on a cut sheet as well as on a paper roll.

### BRIEF DESCRIPTION OF DRAWINGS

FIG. 1 is a perspective view of a printer of a first embodiment;

FIG. 2 is a drawing illustrating the printer of the first embodiment;

FIG. 3 is a drawing illustrating the printer of the first embodiment;

FIG. 4 is a perspective view of the inside of the printer of the first embodiment;

FIG. 5 is a drawing illustrating the printer of the first embodiment;

FIG. 6 is a drawing illustrating the printer of the first embodiment;

FIG. 7A is a drawing illustrating the printer of the first embodiment;

FIG. 7B is a drawing illustrating the printer of the first embodiment;

FIG. 8 is a top view of a paper roll holder;

FIG. 9A is a drawing illustrating the paper roll holder;

FIG. 9B is a drawing illustrating the paper roll holder;

FIG. 10 is a perspective view of the paper roll holder;

FIG. 11 is a perspective view of a first case upper part to which the paper roll holder is attached;

FIG. 12A is a drawing illustrating a paper roll holder of a first variation;

FIG. 12B is a drawing illustrating the paper roll holder of the first variation;

FIG. 13A is a drawing illustrating a paper roll holder of a second variation;

FIG. 13B is a drawing illustrating the paper roll holder of the second variation;

FIG. 14 is a perspective view of a paper roll holder of a third variation;

FIG. 15A is a drawing illustrating the paper roll holder of the third variation;

FIG. 15B is a drawing illustrating the paper roll holder of the third variation;

FIG. 16 is a perspective view of a paper roll holder of a fourth variation;

FIG. 17A is a drawing illustrating a paper roll holder of a fifth variation;

FIG. 17B is a drawing illustrating the paper roll holder of the fifth variation;

FIG. 18 is a perspective view of a printer to which the paper roll holder of the fifth variation is attached;

FIG. 19A is a drawing illustrating the paper roll holder of the fifth variation;

FIG. 19B is a drawing illustrating the paper roll holder of the fifth variation;

FIG. 20A is a drawing illustrating a printer of a second embodiment;

FIG. 20B is a drawing illustrating the printer of the second embodiment;

FIG. 21A is a drawing illustrating the printer of the second embodiment;

FIG. 21B is a drawing illustrating the printer of the second embodiment;

FIG. 22A is a drawing illustrating the printer of the second embodiment;

FIG. 22B is a drawing illustrating the printer of the second embodiment;

FIG. 23A is a drawing illustrating the printer of the second embodiment; and

FIG. 23B is a drawing illustrating the printer of the second embodiment.

### DESCRIPTION OF EMBODIMENTS

Embodiments of the present invention are described below. The same reference number is assigned to the same component, and repeated descriptions of the same component are omitted.

### First Embodiment

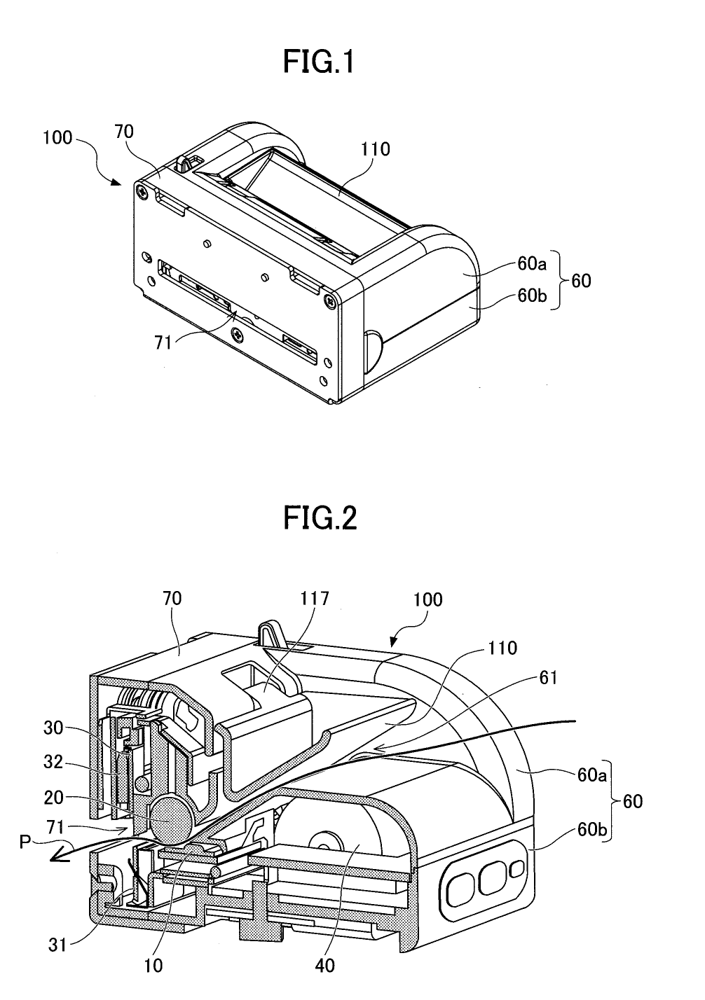

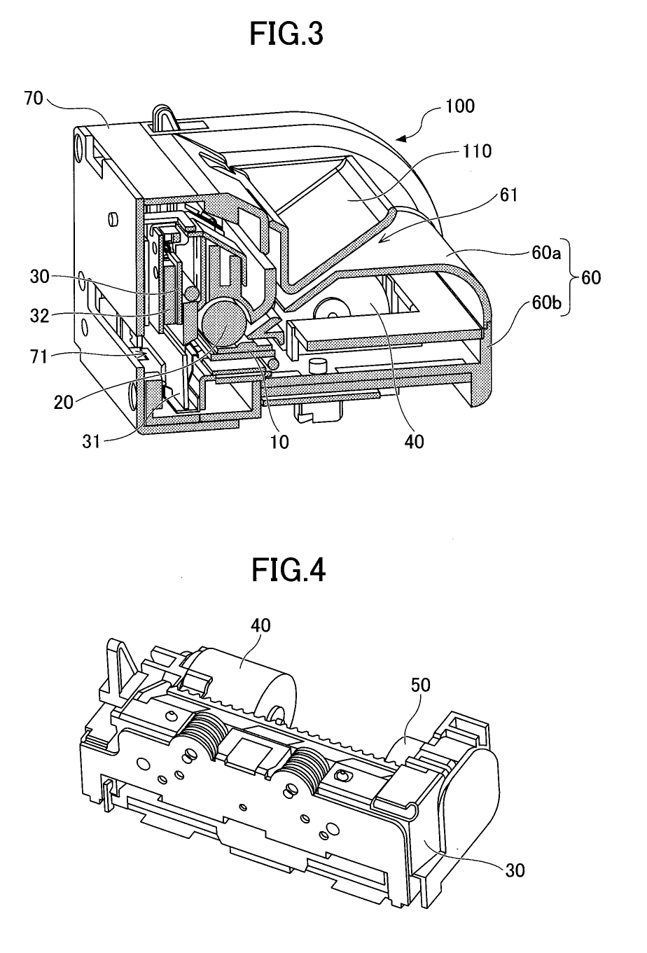

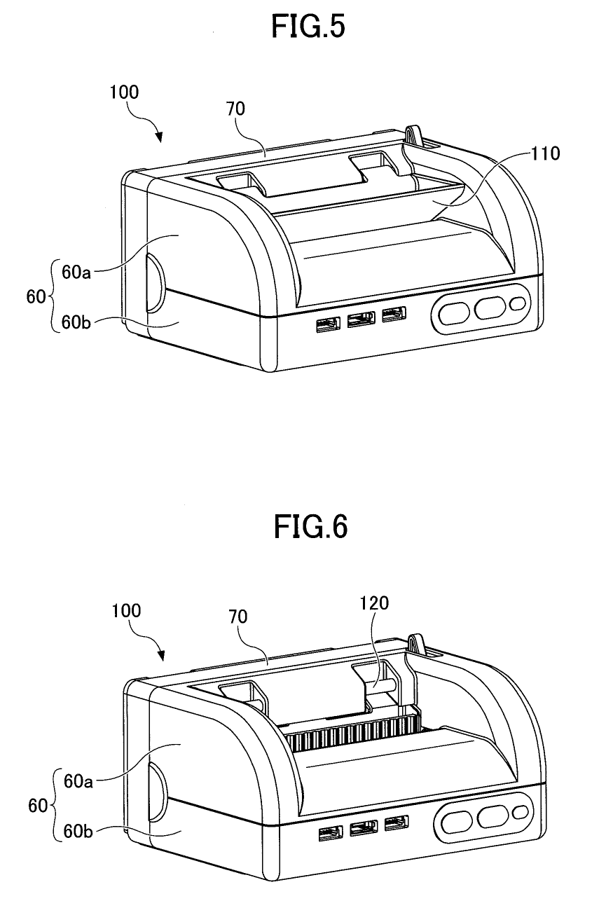

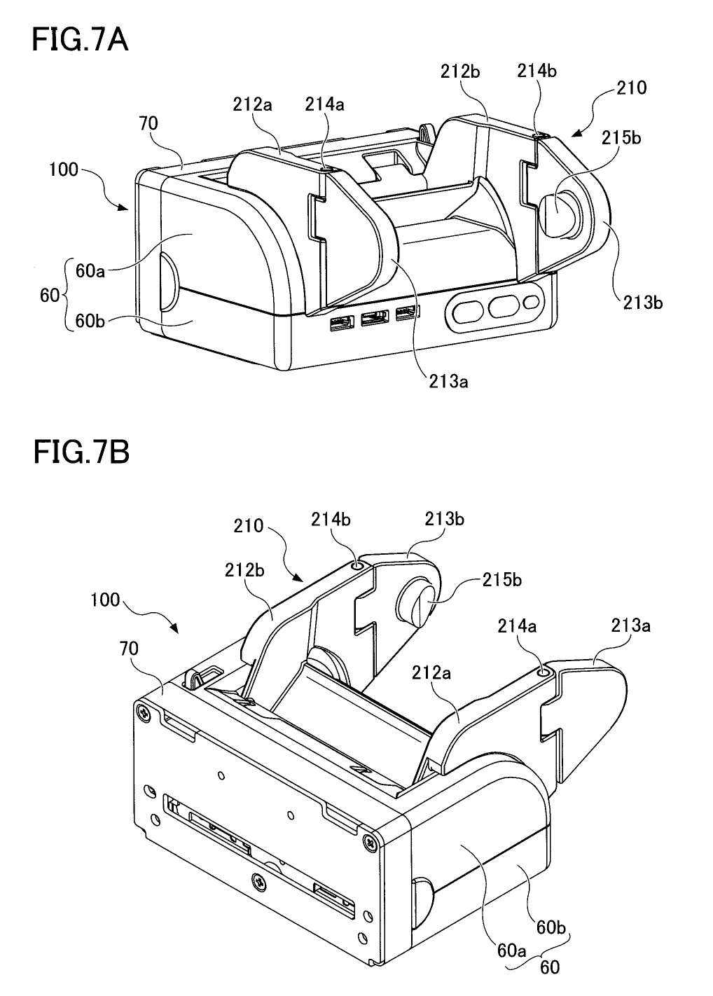

A printer 100 according to a first embodiment is described with reference to FIGS. 1 through 19B. FIG. 1 is a perspective view of the printer 100 of the first embodiment, FIGS. 2 and 3 are cross-sectional perspective views of the printer 100 seen from different directions, and FIG. is a perspective view of a printer mechanism provided inside of the printer 100.

The printer 100 includes a thermal head 10 that is a recording head, a platen roller 20, a cutter 30, a feeding motor 40, and a cutter motor 50. The thermal head 10, the platen roller 20, the feeding motor 40, and the cutter motor 50 are housed in a first case 60. The cutter 30 is attached to a second case 70. The cutter 30 includes a fixed blade 31 and a movable blade 32 that is moved by the cutter motor 50 in the vertical direction in the figures.

The first case 60 includes a first case upper part 60a and a first case lower part 60b that can be separated from each other. In the present embodiment, the first case 60 is formed of a resin, and the second case 70 is formed of a sheet metal. However, the first case 60 and the second case 70 may also be formed of other materials.

Recording paper is inserted through a paper-feed port 61 (first opening) formed in the first case 60 into the printer 100, passes through a gap between the thermal head 10 and the platen roller 20, and is ejected from a paper-ejection port 71 (second opening) formed in the second case 70. In FIG. 2, “P” indicates a conveying path of the recording paper.

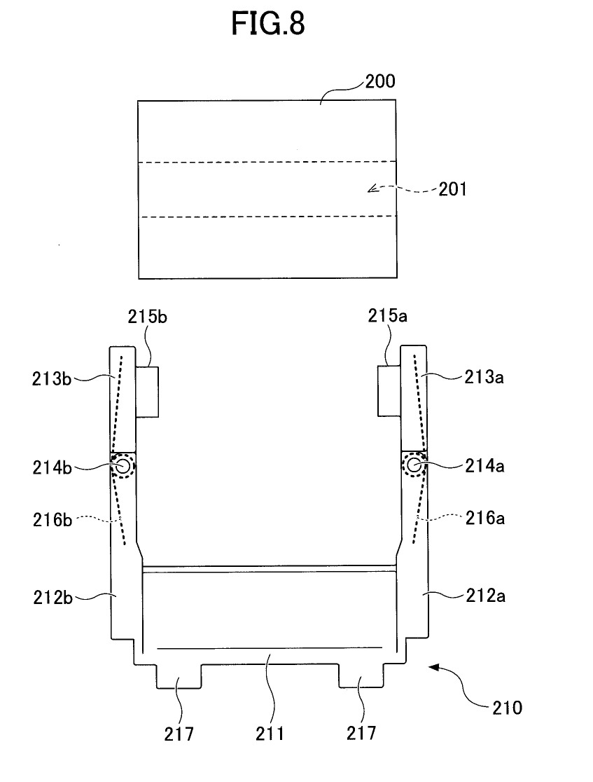

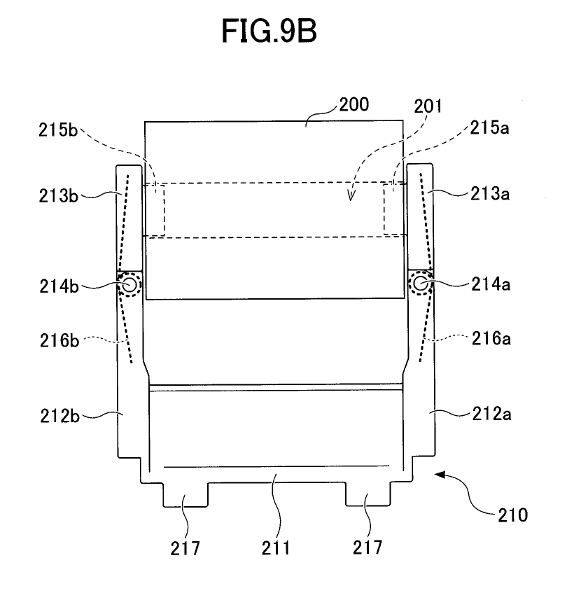

When the printer 100 is incorporated in, for example, a ticketing device that uses cut sheets as recording paper, a recording paper guide 110 for guiding cut sheets is provided at the paper-feed port 61 as also illustrated in FIG. 5. On the other hand, when the printer 100 also uses rolled recording paper (“paper roll”), a paper roll holder (hereinafter “holder”) 210 illustrated in FIGS. 7A and 7B for holding the paper roll can be attached to the printer 100 instead of the recording paper guide 110. This enables the printer 100 to print information also on a paper roll and widens the use of the printer 100. FIGS. 7A and 7B are different perspective views of the printer 100 to which the holder 210 is attached.

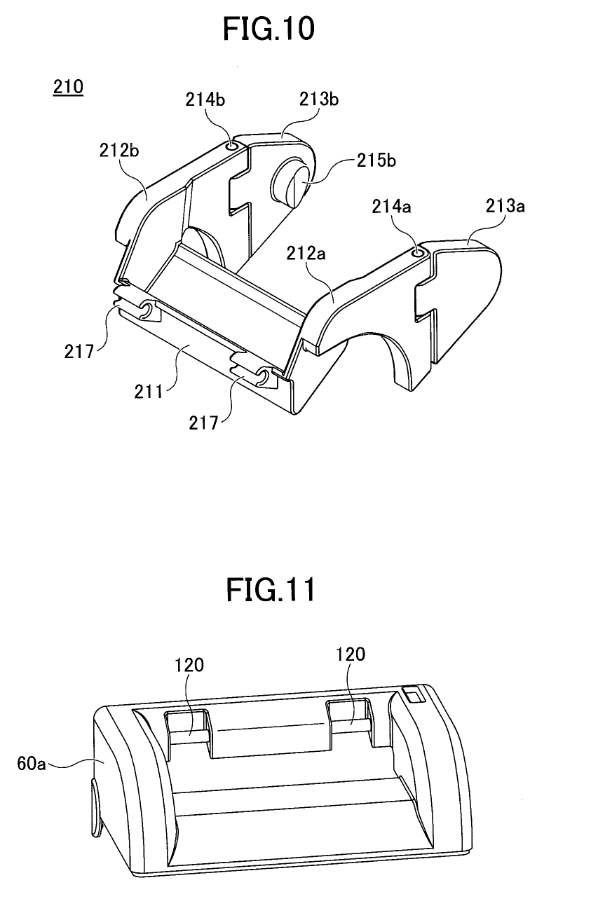

Referring to FIGS. 7A, 7B, and 8, the holder 210 includes a holder body 211 and arm parts 212a and 212b that extend from the lengthwise (lateral) ends of the holder body 211 in a direction substantially orthogonal to the lengthwise direction of the holder body 211. A support arm 213a is attached to an end of the arm part 212a, and a support arm 213b is attached to an end of the arm part 212b. A rotary shaft 214a is provided at a joint between the arm part 212a and the support arm 213a. The support arm 213a is rotatably attached to the arm part 212a via the rotary shaft 214a. A rotary shaft 214b is provided at a joint between the arm part 212b and the support arm 213b. The support arm 213b is rotatably attached to the arm part 212b via the rotary shaft 214b. Protrusions 215a and 215b are provided near the ends of the support arms 213a and 213b, respectively. The protrusions 215a and 215b face each other and are inserted into the center of a paper roll 200.

A torsion coil spring 216a is provided in the arm part 212a and the support arm 213a. One end of the torsion coil spring 216a is connected to the arm part 212a, and another end of the torsion coil spring 216a is connected to the support arm 213a. Similarly, a torsion coil spring 216b is provided in the arm part 212b and the support arm 213b.

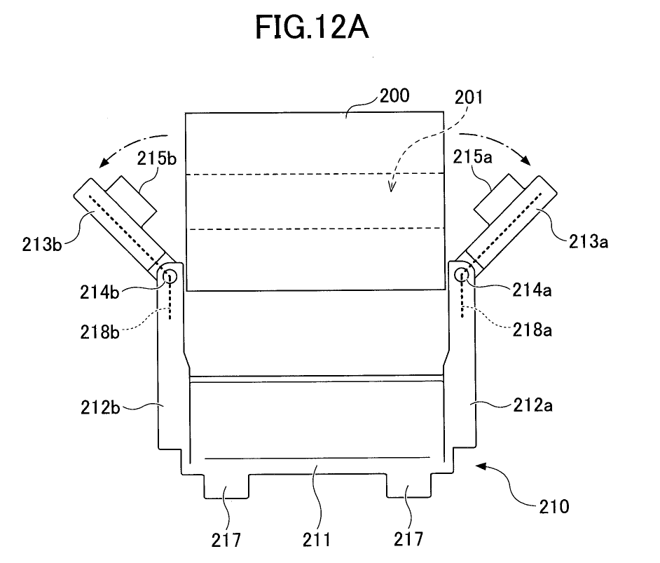

The torsion coil springs 216a and 216b bias the support arms 213a and 213b in such directions that the protrusions 215a and 215b move toward each other. In the first embodiment, when installing the paper roll 200, the support arms 213a and 213b are opened and the paper roll 200 is placed between the support arms 213a and 213b as illustrated in FIG. 9A. More specifically, force is manually applied to the support arms 213a and 213b to rotate the support arms 213a and 213b around the rotary shafts 214a and 214b and move the protrusions 215a and 215b away from each other, and the paper roll 200 is placed between the support arms 213a and 213b. Then, when the support arms 213a and 213b are released, the support arms 213a and 213b rotate in such directions that the protrusions 215a and 215b move toward each other due to the biasing force of the torsion coil springs 216a and 216b, and the protrusions 215a and 215b enter a hole 201 of the paper roll 200 to support the paper roll 200.

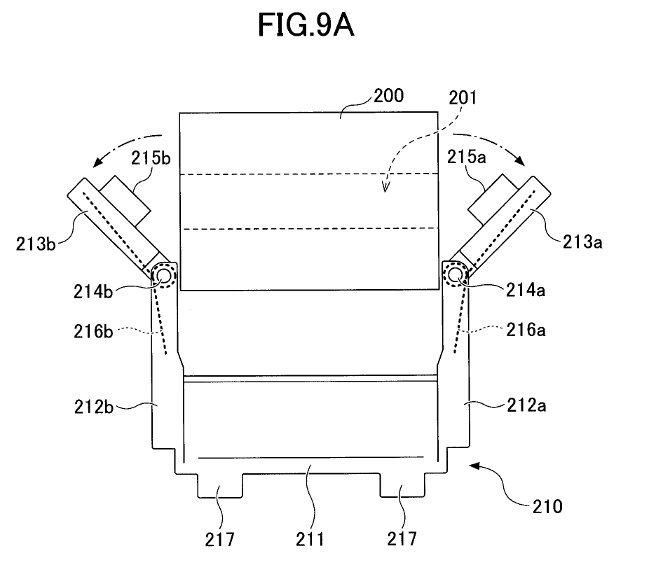

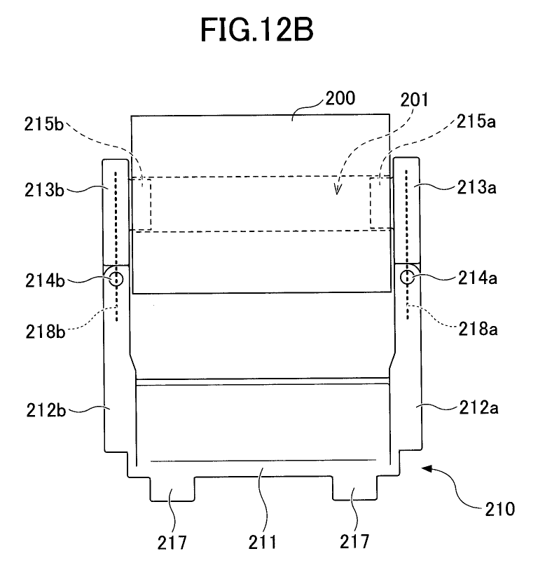

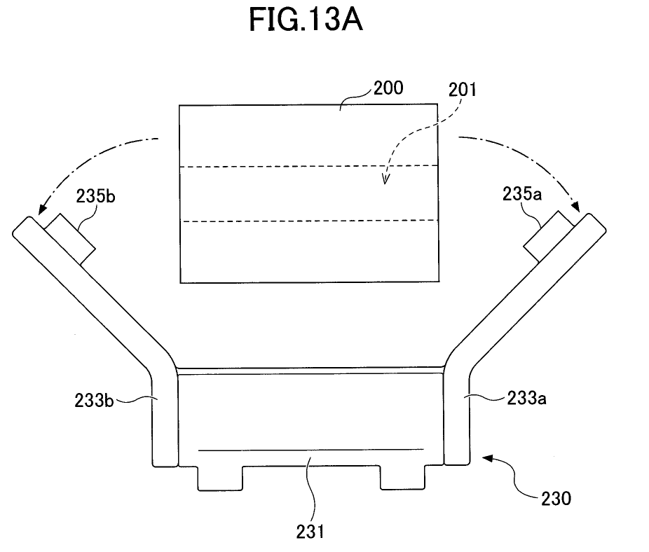

Next, a configuration for attaching the holder 210 is described. In the first embodiment, as illustrated in FIG. 10, attachment hooks 217 for attaching the holder 210 to the printer 100 are provided on the holder body 211. The holder 210 is removably attached to the first case upper part 60a by placing attachment shafts 120 of the first case upper part 60a illustrated in FIGS. 6 and 11 in the attachment hooks 217. Also, as illustrated in FIG. 2, the recording paper guide 110 also includes similar attachment hooks 117. The recording paper guide 110 is removably attached to the first case upper part 60a by placing the attachment shafts 120 in the attachment hooks 117.

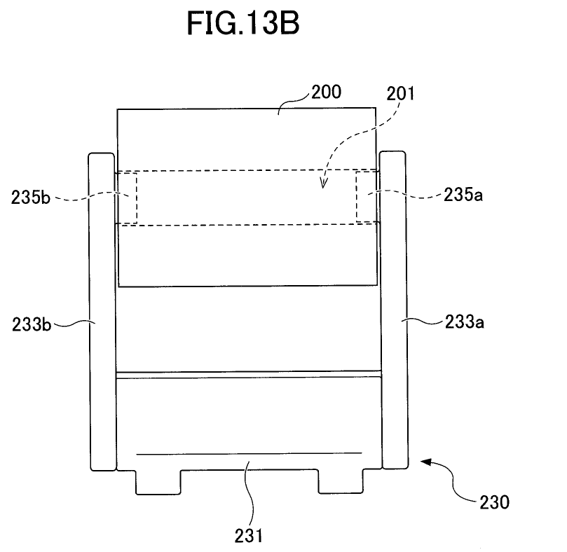

In the above-described example, the holder 210 includes the torsion coil springs 216a and 216b. As another example, as illustrated in FIGS. 12A and 12B, plate springs 218a and 218b may be used instead of the torsion coil springs 216a and 216b. FIG. 12A illustrates the holder 210 where the support arms 213a and 213b are open, and FIG. 12B illustrates the holder 210 where the support arms 213a and 213b are closed and the paper roll 200 is installed.

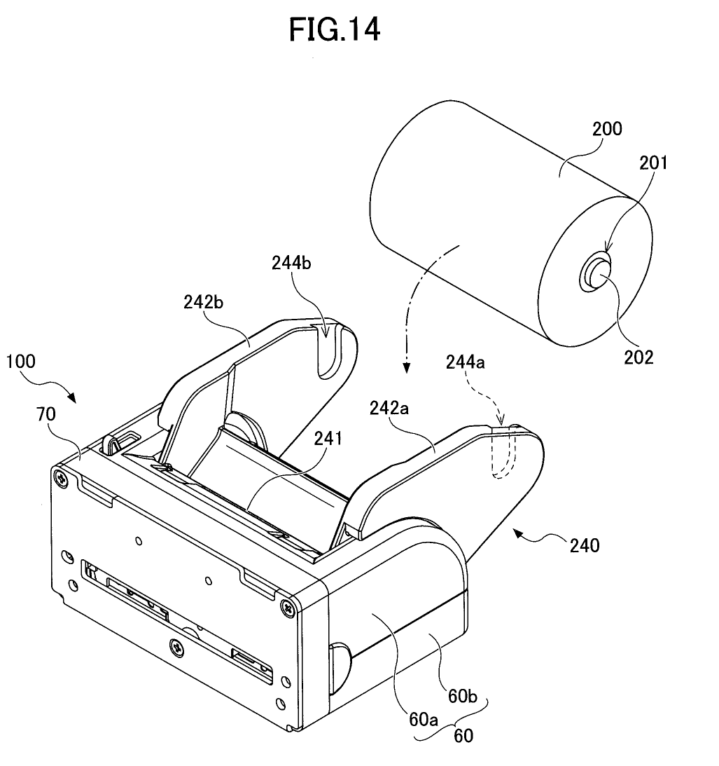

Also, as illustrated in FIGS. 13A and 13B, a holder 230 may be used instead of the holder 210. The holder 230 includes plate-spring arms 233a and 233b each of which is formed of a spring material such as a metal and formed as a monolithic part by combining the arm and the support arm. More specifically, the holder 230 includes a holder body 231, and the arms 233a and 233b are provided at the lengthwise (lateral) ends of the holder body 231. Protrusions 235a and 235b for supporting the paper roll 200 are provided near the ends of the arms 233a and 233b, respectively. When installing the paper roll 200, as illustrated in FIG. 13A, the arms 233a and 233b are bent such that a gap between the protrusions 235a and 235b is widened, and the paper roll 200 is placed between the arms 233a and 233b. Then, as illustrated in FIG. 13B, the protrusions 235a and 235b are biased toward each other by the elasticity of the arms 233a and 233b and enter the hole 201 of the paper roll 200 to support the paper roll 200.

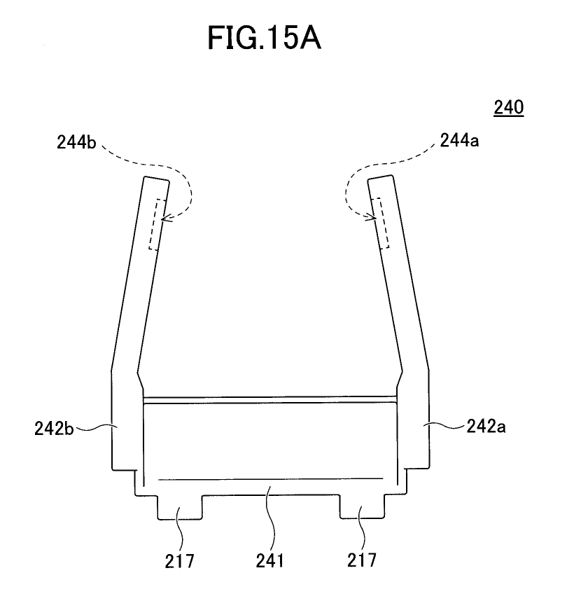

Also in the first embodiment, as illustrated in FIG. 14, the holder 210 may be replaced with a holder 240 that supports a paper-feed shaft (hereinafter “shaft”) 202 placed in the hole 201 of the paper roll 200. The holder 240 includes a holder body 241 and support arms 242a and 242b provided at the ends of the holder body 241. Support recesses 244a and 244b for supporting the shaft 202 are formed to face each other near the ends of the support arms 242a and 242b. Upper ends of the support recesses 244a and 244b are open, and lower ends of the support recesses 244a and 244b are closed. Thus, the shaft 202 is inserted downward into the support recesses 244a and 244b and supported by the support recesses 244a and 244b.

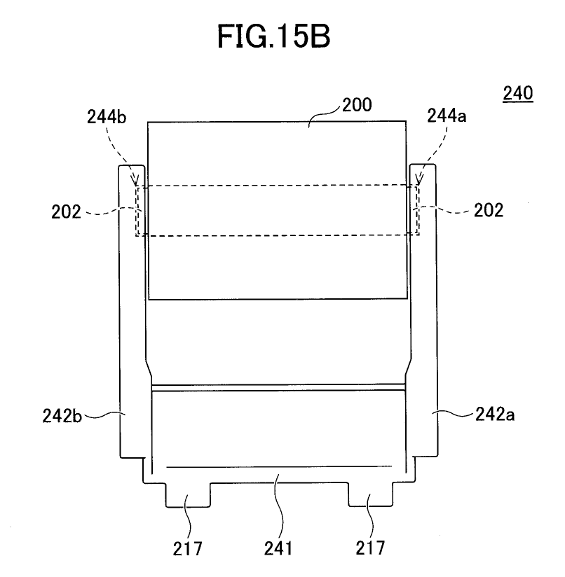

The support arms 242a and 242b of the holder 240 are formed of an elastic material. When the paper roll 200 is not installed, the support recesses 244a and 244b are positioned closer to each other as illustrated in FIG. 15A. As illustrated in FIG. 15B, in a state where the shaft 202 is in the support recesses 244a and 244b, the support arms 242a and 242b are biased due to their elasticity in directions to sandwich and support the shaft 202.

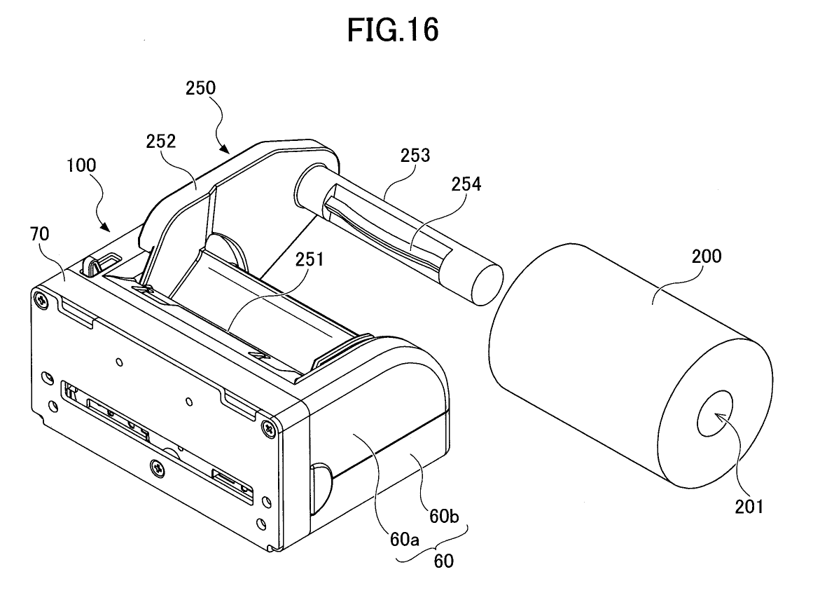

Also in the first embodiment, as illustrated in FIG. 16, the holder 210 may be replaced with a holder 250 that supports the paper roll 200 with a cantilever shaft 253. The holder 250 includes a holder body 251, a support arm 252 provided at one lengthwise (lateral) end of the holder body 251, and the shaft 253 that is attached to the support arm 252 and to be inserted into the hole 201 of the paper roll 200. The shaft 253 includes a spring 254 that presses the inner surface of the hole 201 of the paper roll 200 outward to keep the paper roll 200 on the shaft 253.

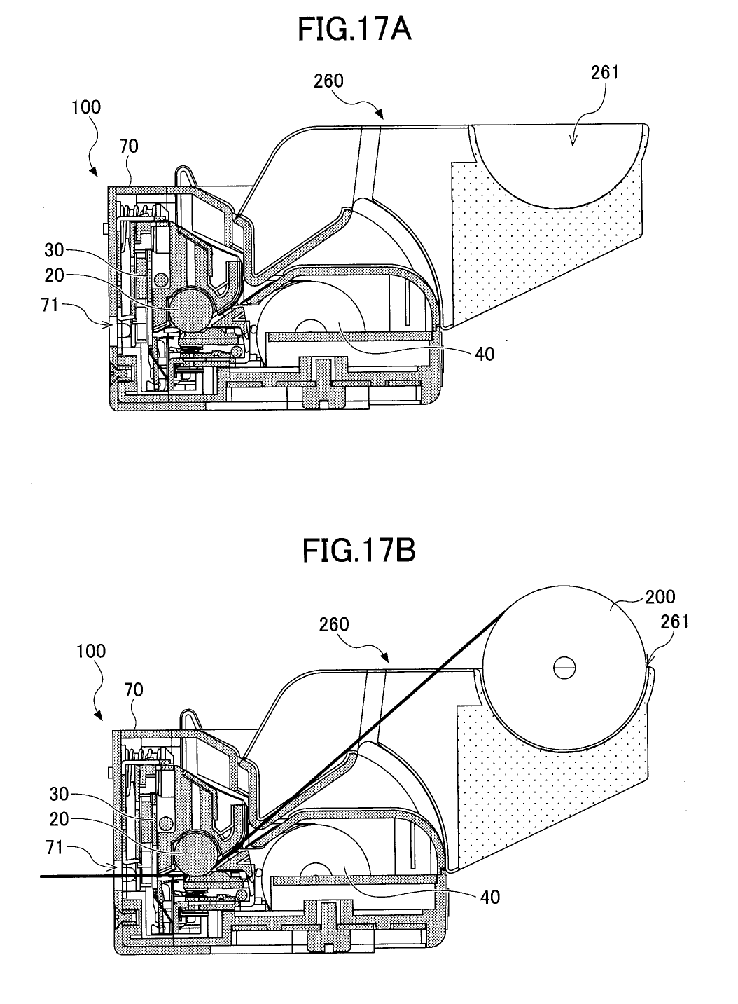

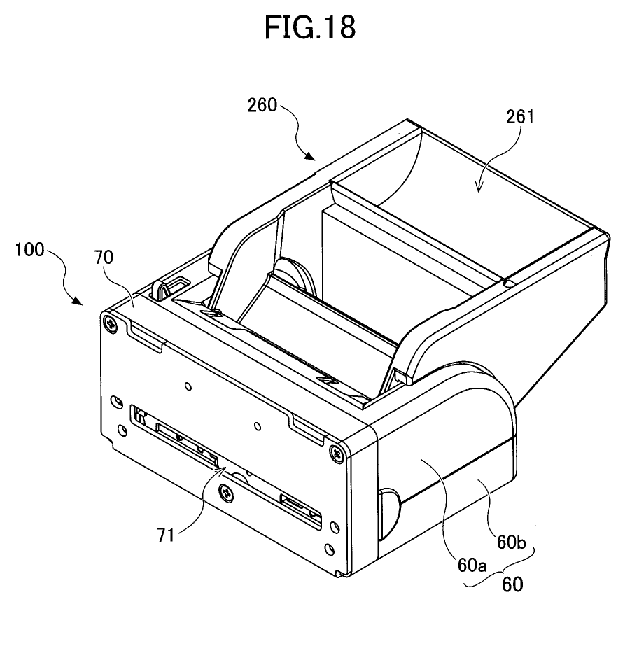

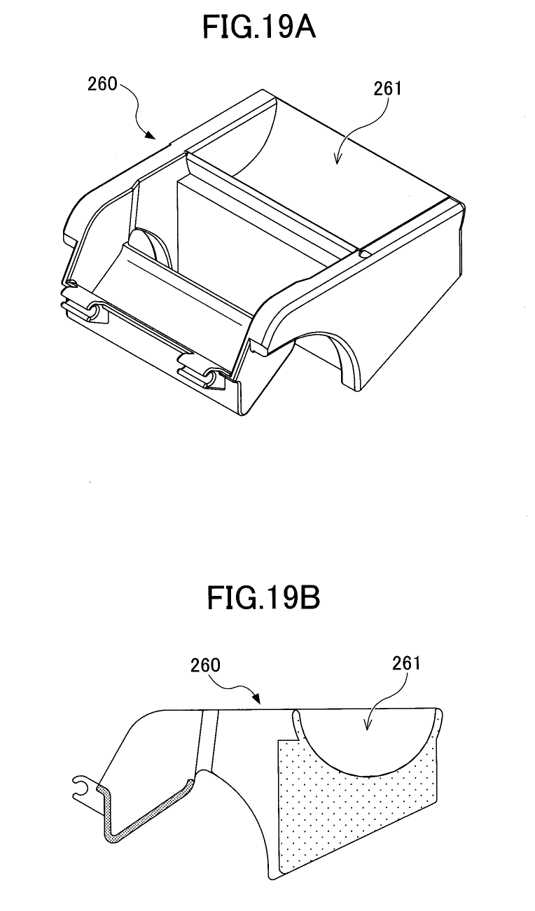

Also in the first embodiment, as illustrated in FIGS. 17A, 17B, and 18, the holder 210 may be replaced with a drop-in-type holder 260. As illustrated in FIGS. 17A, 18, 19A, and 19B, the holder 260 includes a receptacle 261 for holding the paper roll 200. As illustrated in FIG. 17B, the paper roll 200 can be placed in the receptacle 261. FIGS. 17A and 17B are cross-sectional views and FIG. 18 is a perspective view of the printer 100 to which the holder 260 is attached. FIG. 19A is a perspective view and FIG. 19B is a cross-sectional view of the holder 260.

In the above embodiment, the recording paper guide 110 is used for cut sheets and a holder is used for a paper roll. However, the printer 100 may be configured to be able to print information also on a cut sheet even when a holder is attached. In this case, because the printer 100 can use both cut sheets and a paper roll with a holder attached, it is not necessary to replace the holder with the recording paper guide 110.

### Second Embodiment

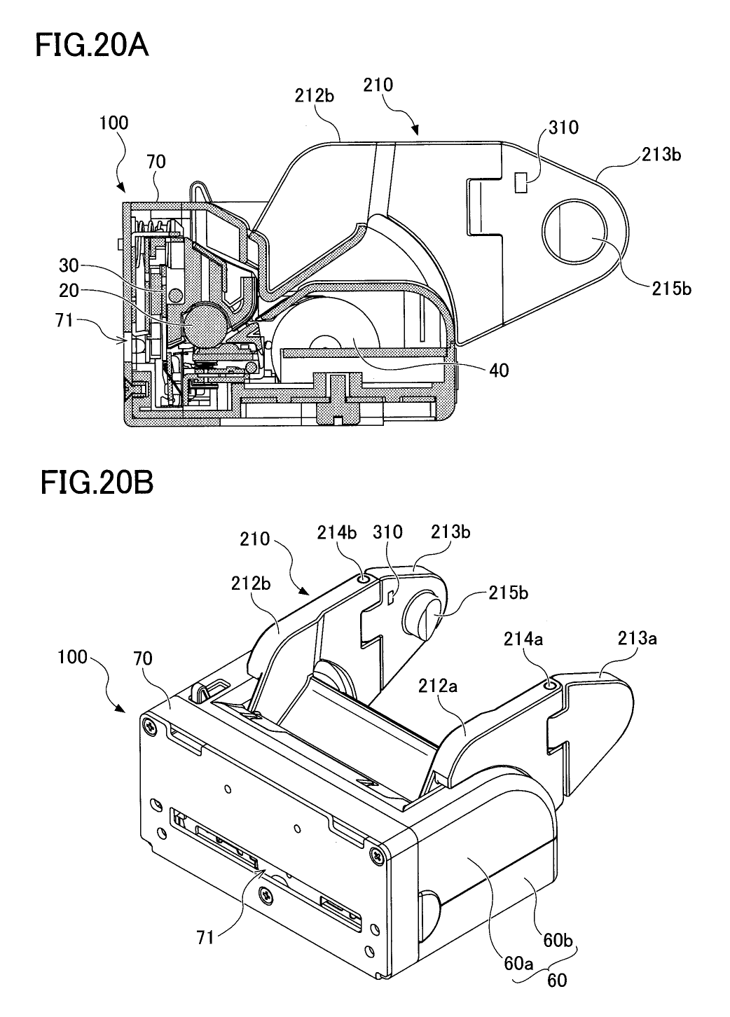

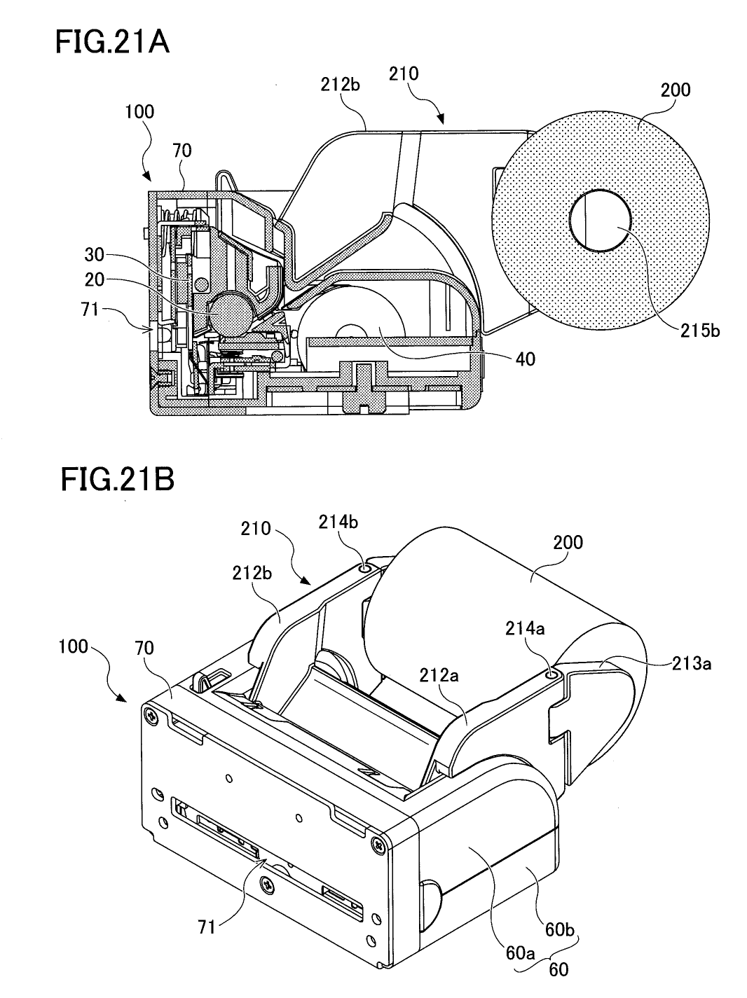

Next, a second embodiment is described. In the second embodiment, as illustrated in FIGS. 20A, 20B, 21A, and 21B, a holder 210 includes a sensor 310 for detecting a paper roll. FIGS. 20A and 20B are a cross-sectional view and a perspective view of the printer 100 before the paper roll 200 is set in the holder 210. FIGS. 21A and 21B are a cross-sectional view and a perspective view of the printer 100 in a state where the paper roll 200 is set in the holder 210.

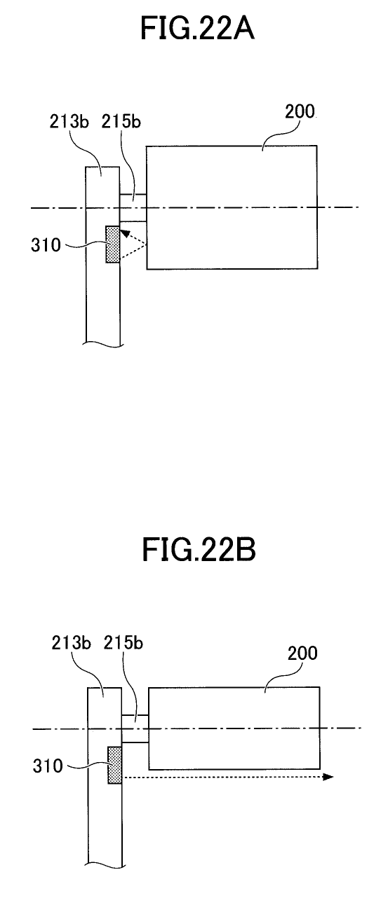

In the second embodiment, as illustrated in FIGS. 22A and 22B, an optical reflection sensor may be used as the sensor 310. FIG. 22A illustrates a state where a sufficient amount of the paper roll 200 remains, and FIG. 22B illustrates a near-end state where a small amount of remaining paper roll 200 remains. As illustrated in FIG. 22A, when a sufficient amount of the paper roll 200 remains, light emitted from a light emitter of the sensor 310 is reflected by a side surface of the paper roll 200 and is detected by a light receiver of the sensor 310 as indicated by a dotted arrow. As illustrated in FIG. 22B, in the near-end state where the diameter of the paper roll 200 is small, light emitted from the light emitter of the sensor 310 goes straight instead of being reflected by the side surface of the paper roll 200 as indicated by a dotted arrow and is therefore not detected by the light receiver of the sensor 310. This configuration makes it possible to detect the near-end state of the paper roll 200.

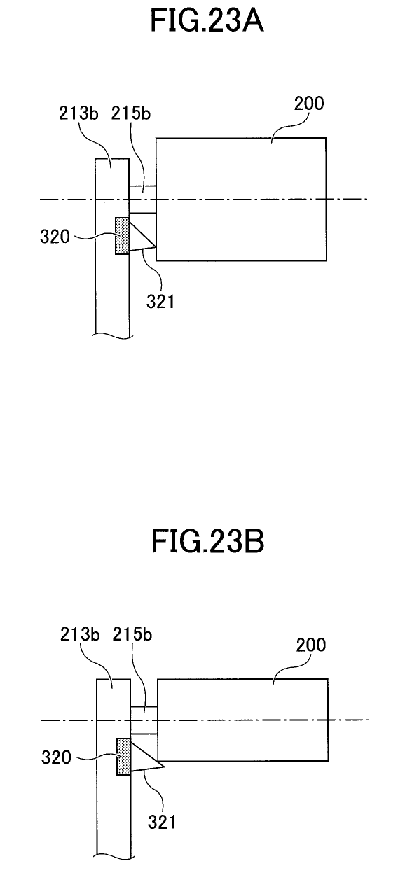

Also in the second embodiment, as illustrated in FIGS. 23A and 23B, a mechanical switch sensor 320 including a switch 321 may be used. The switch 321 of the mechanical switch sensor 320 is pressed and turned on in a state as illustrated in FIG. 23A. On the other hand, in the near-end state illustrated in FIG. 23B, the paper roll 200 is out of contact with the switch 321, and the switch 321 rises (or protrudes) and is turned off. This configuration makes it possible to detect the near-end state of the paper roll 200.

Configurations of the second embodiment other than those described above may be substantially the same as those of the first embodiment.

A printer according to embodiments of the present invention is described above. However, the present invention is not limited to the specifically disclosed embodiments, and variations and modifications may be made without departing from the scope of the present invention.

### EXPLANATION OF REFERENCE NUMERALS

60 First case
60a First case upper part
60b First case lower part
61 Paper-feed port
70 Second case
71 Paper-ejection port
100 Printer
110 Recording paper guide
120 Attachment shaft
210 Paper roll holder
211 Holder body
212a, 212b Arm
213a, 213b Support arm
214a, 214b Rotary shaft
215a, 215b Protrusion
216a, 216b Torsion coil spring

1. A printer, comprising:
a platen roller that feeds recording paper supplied through a first opening toward a second opening through which the recording paper is ejected;
a recording head that prints information on the recording paper; and
an attachment part to which a recording paper guide that guides the recording paper or a holder that supports a roll of the recording paper is detachably attached.

2. The printer as claimed in claim 1, wherein
the holder includes
a body,
a first arm and a second arm extending from ends of the body, and
a first support and a second support that are provided on the first arm and the second arm so as to face each and support the roll of the recording paper; and
the first arm and the second arm are biased in such directions that the first support and the second support move toward each other.

3. The printer as claimed in claim 2, wherein
the first arm and the second arm include
a first arm part and a second arm part provided on the body,
a first support arm and a second support arm that are rotatably attached to the first arm part and the second arm part and include the first support and the second support, and
a first biasing part and a second biasing part that bias the first support arm and the second support arm in such directions that the first support and the second support move toward each other.

4. The printer as claimed in claim 1, wherein the holder includes
a body;
a support arm that extends from one end of the body; and
a shaft that is attached to the support arm and supports the roll of the recording paper.

5. The printer as claimed in claim 1, wherein the holder includes
a body; and
a receptacle that is provided in the body and in which the roll of the recording paper is placed.
